(19) United States
(12) Patent Application Publication
(10) Pub. No.: US 2013/0156180 A1
(43) Pub. Date: Jun. 20, 2013

(54) Method And Device For Securing Block Ciphers Against Template Attacks

(71) Applicant: Siemens Aktiengesellschaft, Munchen (DE)

(72) Inventor: Erwin Hess, Ottobrunn (DE)

(73) Assignee: SIEMENS AKTIENGESELLSCHAFT, Munchen (DE)

(21) Appl. No.: 13/711,724

(22) Filed: Dec. 12, 2012

(30) Foreign Application Priority Data
Dec. 14, 2011 (DE) 10 2011 088 502.1

(51) Int. Cl. H04L 9/28

(52) U.S. Cl. CPC H04L 9/28
USPC 380/28

(57) ABSTRACT

A method for securing a block cipher F, encrypted with a working key K₀, against template attacks is provided. A working permutation F(K₀) fixed by the block cipher F and the working key K₀, and a number N of dummy permutations G(K₁), . . . , G(Kₙ) are provided. The N dummy permutations G(K₁), . . . , G(Kₙ) are fixed by N dummy keys K₁, . . . , Kₙ and the block cipher F or the inverse F⁻¹ of the block cipher F. The working permutation F(K₀) and the N dummy permutations G(K₁), . . . , (G(Kₙ) are chained to form a chain H in such a way that the chain H and the working permutation F(K₀) produce an identical image (H=F(K₀)). A block cipher F, in which a fixed key K₀ is used, is protected against template attacks as a result. A computer program product and a device for securing a block cipher F against template attacks are also proposed.

### CROSS-REFERENCE TO RELATED APPLICATIONS

This application claims priority to DE Patent Application No. 10 2011 088 502.1 filed Dec. 14, 2011. The contents of which is incorporated herein by reference in its entirety.

### TECHNICAL FIELD

The present disclosure relates to the securing of block ciphers against template attacks.

### BACKGROUND

A block cipher is a symmetrical encryption method in which the plain text to be encrypted is broken down into a sequence of blocks having the same length, by way of example the length 64 bits or 128 bits. Each block of plaintext is mapped onto a cipher block of the same length. Typical examples of block ciphers are the DES algorithm (DES, Data Encryption Standard) having a block width of 64 bits and the AES algorithm (AES, Advanced Encryption Standard) having a block width of 128 bits. Block ciphers are conventionally used if a large volume of data is to be encrypted.

Implementations of block ciphers are typically sometimes attacked using template attacks.

Template attacks belong to the category of side channel attacks. These are attacks against specific implementations of cryptographic methods which utilize physical side effects of the cryptographic sequences. Examples of such physical side effects are the required computing time, the resulting current profile and the electromagnetic radiation. The template attacks are not attacks against the cryptographic method per se, however.

In the case of a template attack it is assumed that the attacker has full access to a training implementation of the cryptographic method which is identical in terms of model in hard- and software to the actual target implementation which is to be attacked. Only the key or keys of the cryptographic method, whose implementation is to be attacked, are not available on the training implementation. A commonality of all template attacks lies in recording the characteristic of the current consumption curve for a number of input data from plain-texts and self-selected keys and then developing a model which optimally describes the dependency of the current consumption on the input data. This can be called a learning phase.

After this learning phase with the training implementation the current profile of the actual target platform, which depends on an unknown secret key, is then recorded in a subsequent measuring phase. With the aid of the model, created previously, about the connection between input data and current profile, an attempt is then made to determine the a priori unknown key. This ideally occurs using a single measurement.

It is obvious that the special situation, which forms the basis of the attack scenario of a template attack, does not always exist. Thus platforms with changeable keys may be prevented from coming into circulation at all by way of logistic means for instance. Furthermore, the key memories of a potential training platform may be electronically locked, so that it is virtually impossible to record the required measurement data with self-selected input data at all.

If, however, there is the possibility of a template attack, template attacks are actually the most powerful side channel attacks.

The conventional technical countermeasures against template attacks are firstly the same ones as may also be used against DPA attacks (DPA, Differential Power Analysis). By way of example, the individual dependency of the current consumption on the input data can be reduced by way of electrical smoothing of the implementation, for example by dual-rail logic. Furthermore, the cryptographic algorithm can be randomized in its sequence, by way of example by using random masks or by introducing what are known as “Random Wait States” into the process sequence. Furthermore, the keys used can be changed sufficiently frequently.

However, there are implementation situations in which a key change in not possible owing to external specifications, for example owing to standards.

### SUMMARY

In one embodiment, a method for securing a block cipher (F), encrypted with a working key (K₀), against template attacks comprises: (a) providing a working permutation (F(K₀)) fixed by the block cipher (F) and the working key (K₀), (b) providing a number N of dummy permutations (G(K₁), . . . , (G(Kₙ)) that are fixed by N dummy keys (K₁, . . . , Kₙ) and the block cipher (F) or an inverse (F⁻¹) of the block cipher (F), and (c) chaining the working permutation (F(K₀) and the dummy permutations (G(K₁), . . . , (G(Kₙ)) to form a chain such that the chain and the working permutation (F(K₀)) produce an identical image.

In a further embodiment, the number N of dummy permutations (G(K₁), . . . , (G(Kₙ)) is provided such that each chain of N dummy permutations (G(K₁), . . . , G(Kₙ)) produces a pre-image set of the block cipher (F).

In a further embodiment, the chain of N dummy permutations is achieved by a first model having (g₁ o g₁⁻¹) o (g₂ o g₂⁻¹) o . . . o (gₙ o gₙ⁻¹), where gᵢ=G(Kᵢ), wherein G designates the block cipher (F) or the inverse (F⁻¹) of the block cipher, and wherein Kᵢ, where iε[1, . . . , n], designates the N dummy keys (K₁, . . . , Kₙ).

In a further embodiment, the chain of N dummy permutations is achieved by a second model having (g₁ o g₂ o . . . . o gₙ) o (gₙ⁻¹ o . . . o g₂⁻¹ o g₁⁻¹), where gᵢ=G(Kᵢ), wherein G designates the block cipher (F) or the inverse (F⁻¹) of the block cipher, and wherein Kᵢ, where ε[1, n], designates the N dummy keys (K₁, . . . , Kₙ).

In a further embodiment, the chain of N dummy permutations is achieved by a third model having (g₁ o g₂ o g₃⁻¹) o (g₃ o g₂⁻¹ o g₁⁻¹) o (g₄ o g₅ o g₆⁻¹) o (g₆ o g₅⁻¹ o g₄⁻¹) o . . . , where gᵢ=G (Kᵢ), wherein G designates the block cipher (F) or the inverse (F⁻¹) of the block cipher, and wherein Kᵢ, where iε[1, . . . , n], designates the N dummy keys (K₁, . . . , Kₙ).

In a further embodiment, an implementation of a triple DES encryption is secured using the third model.

In a further embodiment, the N dummy keys (K₁, . . . , Kₙ are permutated before each application of steps a) to c).

In a further embodiment, the N dummy keys (K₁, . . . , Kₙ) are re-formed before each application of steps a) to c).

In a further embodiment, the working key (K₀) is permanently allocated to the block cipher (F).

In a further embodiment, a computer program product is provided for securing a block cipher (F), encrypted with a working key (K₀), against template attacks, the computer program product being embodied in non-transitory computer readable media and executable by a processor to: provide a working permutation (F(K₀)) fixed by the block cipher (F) and the working key (K₀), provide a number N of dummy permutations (G(K₁), . . . , (G (Kₙ)) that are fixed by N dummy keys (K₁, . . . , Kₙ) and the block cipher (F) or an inverse (F⁻¹) of the block cipher (F), and chain the working permutation (F(K₀)) and the dummy permutations (G(K₁), . . . , (G(Kₙ)) to form a chain such that the chain and the working permutation (F(K₀)) produce an identical image.

In another embodiment, a device is provided for securing a block cipher (F), encrypted with a working key (K₀), against template attacks, the device comprising: a first means for providing a working permutation (F(K₀)) fixed by the block cipher (F) and the working key (K₀), a second means for providing a number N of dummy permutations (G(K₁), . . . , G(Kₙ)), which are fixed by N dummy keys (K₁, . . . , Kₙ and the block cipher (F) or the inverse (F⁻¹) of the block cipher (F), and a third means for chaining the working permutation (F(K₀)) and the dummy permutations (G(K₁), . . . , G(Kₙ)) to form a chain (H) in such a way that the chain (H) and the working permutation (F(K₀)) produce an identical image. In another embodiment, a processor includes such a device.

### BRIEF DESCRIPTION OF THE DRAWINGS

Example embodiments will be explained in more detail below with reference to figures, in which:

FIG. 1 shows a flowchart of an exemplary embodiment of a method for securing a block cipher against template attacks;

FIG. 2 shows a block diagram of an exemplary embodiment of a device for securing a block cipher against template attacks;

FIG. 3 shows a block diagram of an exemplary embodiment of a processor having a device according to FIG. 2; and

FIG. 4 shows a block diagram of a further exemplary embodiment of a device for securing a block cipher against template attacks.

### DETAILED DESCRIPTION

Embodiment of the present disclosure are configured to protect a block cipher, in which a fixed key is used, against template attacks.

For example, a method for securing a block cipher F, encrypted with a working key K₀, against template attacks is proposed. A working permutation F(K₀) fixed by the block cipher F and the working key K₀, and a number N of dummy permutations G(K₁), . . . , G(Kₙ) are provided. The N dummy permutations G(K₁), . . . , G(Kₙ) are fixed by N dummy keys K₁, . . . , Kₙ and the block cipher F or the inverse F⁻¹ of the block cipher F. The working permutation F(K₀) and the N dummy permutations G(K₁), . . . , (G(Kₙ) are chained to form a chain H in such a way that the chain H and the working permutation F(K₀) produce an identical image (H=F(K₀)).

The permutation F(K₀) fixed by the block cipher F and the keys K₀ is then chained to form a product H=G(K₁) o G(K₂) o . . . o G(Kₘ) o F(K₀) o G (_{Km+1}) o G (_{Km+2}) o . . . o G(Kₙ) of permutations in such a way that H=F(K₀) always applies. The working permutation F(K₀) can be advantageously hidden in the chain H thereby, so the probability of a successful template attack is reduced.

The keys K₁, . . . , Kₘ and Kₘ₊₁, . . . , Kₙ used may be re-formed or at least permutated before each application of F. The block cipher G is chosen as G=F or G=F⁻¹ in this connection.

Use is made of the fact that the pre-image set M of a block cipher is identical to the image set and that the block cipher achieves a permutation to M following selection of a key. The totality of permutations of a set M forms a group with respect to the chain “o” of images. The permutations of M can therefore be chained to each other as desired. The result of the chain is always a permutation of M again. If f₁ and f₂ are two random permutations of M, the effect of the chained permutation f₁ o f₂ is defined by f₁ o f₂(m)=f₁(f₂(m)), if m designates a random element of M. The image of m under the permutation f₂ is therefore the pre-image for the permutation f₁.

In one embodiment the number N of dummy permutations G(K₁), . . . , G(Kₙ) is provided in such a way that a chain of N dummy permutations G(K₁), . . . , G(Kₙ) produces a pre-image set M of the block cipher F.

The permutations G(K₁), . . . , G(Kₙ) are in particular chosen such that G(K₁) o G(K₂) o . . . o G(Kₙ) is the identical image id_{M} on M. The permutations G(Kₘ₊₁), . . . , G(Kₙ) are accordingly also selected such that G(Kₘ₊₁) o G(Kₘ₊₂ ) o . . . o G(Kₙ)=id_{M} applies.

Overall the following applies therefore H=G(K₁) o G(K₂) o . . . o G(Kₘ) o F(K₀) o G(Kₘ₊₁) o G(Kₘ₊₂) o . . . o G(Kₙ)=(G(K₁) o G(K₂) o . . . o G(Kₘ)) o F(K₀) o (G(_{Km+1}) o G(Kₘ₊₂) o . . . o G(Kₙ))=id_{M} o F(K₀) o id_{M}=F(K₀).

G(K₁) o G(K₂) o . . . o G(Kₘ) and G(Kₘ₊₁) o G(K₂) o . . . o G(Kₙ) thereby achieve redundant representations of the identical image id_{M}.

The following methods show how these redundant representations of the identical image may be easily obtained. gᵢ:=G(Kᵢ) is used to simplify notation.

Method 1: id=G(K₁) o G(K₂) o . . . o G(Kₘ) is from the model (g₁ o g₁⁻¹) o (g₂ o g₂⁻¹) o . . . o (gₘ o gₘ ⁻¹)

Method 2: id=G(K₁) o G(K₂) o . . . o G(Kₘ) is from the model (g₁ o g₂ o . . . o gₘ) o (gₘ⁻¹ o . . . o g₂⁻¹ o g₁⁻¹)

Method 3: id=G(K₁) o G(K₂) o . . . o G(Kₘ) is from the model (g₁ o g₂ o g₃⁻¹) o (g₃ o g₂⁻¹ o g₁⁻¹) o (g₄ o g₅ o g₆⁻¹) o (g₆ o g₅⁻¹ o g₄⁻¹) o . . .

Furthermore, random mixed forms of the three said methods are possible. The described procedure is also valid for the permutation G(Kₘ₊₁) o G(K₂) o . . . o G(Kₙ).

Method 3 is particularly suitable if implementations of the triple DES algorithm are to be secured.

According to the certain embodiment the possibility, which basically always exists, of iterating block ciphers may be used to secure an implementation of a block cipher against template attacks.

The iteration of block ciphers would conventionally only be used to increase the key space of an algorithm. A known example of this approach is the triple DES, which—in the above notation—causes a permutation of the model g₁ o g₂ o g₃⁻¹ after three keys have been chosen.

Block ciphers are typically constructed in such a way that a rounding function is iterated several times. In each round a new partial key is used which is derived from the chosen key in accordance with a specified pattern, which is known as Key Scheduling. As a rule, the permutation f—i.e. f=F(K)—, formed by a block cipher F following selection of a key K, differs from the associated inverse permutation f⁻¹ only by a different Key Scheduling. f⁻¹ can consequently also be achieved by the block cipher F.

This results in a method for securing block ciphers, which are operated with a fixed key, against template attacks which is very easy to implement. The actual implementation of the block cipher can be unchanged, only the loop counter, which controls the number of iterations—the rounding function—, is increased.

Key Scheduling is modified such that it achieves a sequence of permutations as described above, see method 1 to method 3.

In a further embodiment the chain of N dummy permutations G(K₁), . . . , G(Kₙ) is achieved by a first model having (g₁ o g₁⁻¹) o (g₂ o g₂⁻¹) o . . . o (gₙ o gₙ⁻¹), where gᵢ=G(Kᵢ), wherein G designates the block cipher F or the inverse F⁻¹ of the block cipher F and wherein Kᵢ, where iε[1, . . . , n], designates the N dummy keys K₁, . . . , Kₙ.

In a further embodiment the chain of N dummy permutations G(K₁), . . . , G(Kₙ) is achieved by a second model having (g₁ o g₂ o . . . o gₙ) o (gₙ⁻¹ o . . . o g₂⁻¹ o g₁⁻¹), where gᵢ=G(Kᵢ), wherein G designates the block cipher F or the inverse F⁻¹ of the block cipher F and wherein Kᵢ, where iε[1, . . . , n], designates the N dummy keys K₁, . . . , Kₙ.

In a further embodiment the chain of N dummy permutations is achieved by a third model having (g₁ o g₂ o g₃⁻¹) o (g₃ o g₂⁻¹ o g₁⁻¹) o (g₄ o g₅ o g₆⁻¹) o (g₆ o g₅⁻¹ o g₄⁻¹) o . . . , where gᵢ=G(Kᵢ), wherein G designates the block cipher F or the inverse F⁻¹ of the block cipher F and wherein Kᵢ, where iε[1, . . . , n], designates the N dummy keys K₁, . . . , Kₙ.

In a further embodiment an implementation of a triple DES encryption is secured using the third model.

In a further embodiment the N dummy keys K₁, . . . , Kₙ are permutated before each application of securing.

In a further embodiment the N dummy keys K₁, . . . , Kₙ are re-formed before each application of securing.

In a further embodiment the working key K₀ is permanently allocated to the block cipher F.

A computer program product is also proposed which causes a method, as described above, for securing a block cipher F, encrypted with a working key K₀, against template attacks to be carried out on a program-controlled device.

A computer program product such as a computer program means can be provided or supplied by way of example as a storage medium, such as memory card, USB stick, CD-ROM, DVD or in the form of a file which can be downloaded from a server in a network. This can occur for example in a wireless communications network by the transmission of a corresponding file with the computer program product or computer program means.

A device for securing a block cipher F, encrypted or working with a working key K₀, against template attacks is also proposed which comprises a first means, a second means and a third means. The first means is set up to provide a working permutation F(K₀) fixed by the block cipher F and the working key K₀. The second means is set up to provide a number N of dummy permutations G(K₁), . . . , G(Kₙ). The N dummy permutations G(K₁), . . . , G(Kₙ) are fixed by N dummy keys K₁, . . . , Kₙ and the block cipher F or the inverse F⁻¹ of the block cipher F. The third means is set up to chain the working permutation F(K₀) and the N dummy permutations G(K₁), . . . , G(Kₙ) to form a chain H in such a way that the chain H and the working permutation F(K₀) produce an identical image (H=F(K₀)).

The respective means can be implemented in terms of hardware or software technology. With a hardware implementation the respective means can be constructed as a device or as part of a device, for example as a computer or microprocessor. With a software implementation the respective means can be constructed as a computer program product, a function, a routine, as part of a program code or as an executable object.

A processor having a device as described above for securing a block cipher F, encrypted with a working key K₀, against template attacks is also proposed. The device is implemented by way of example as part of the CPU (CPU, Control Processing Unit) of the processor.

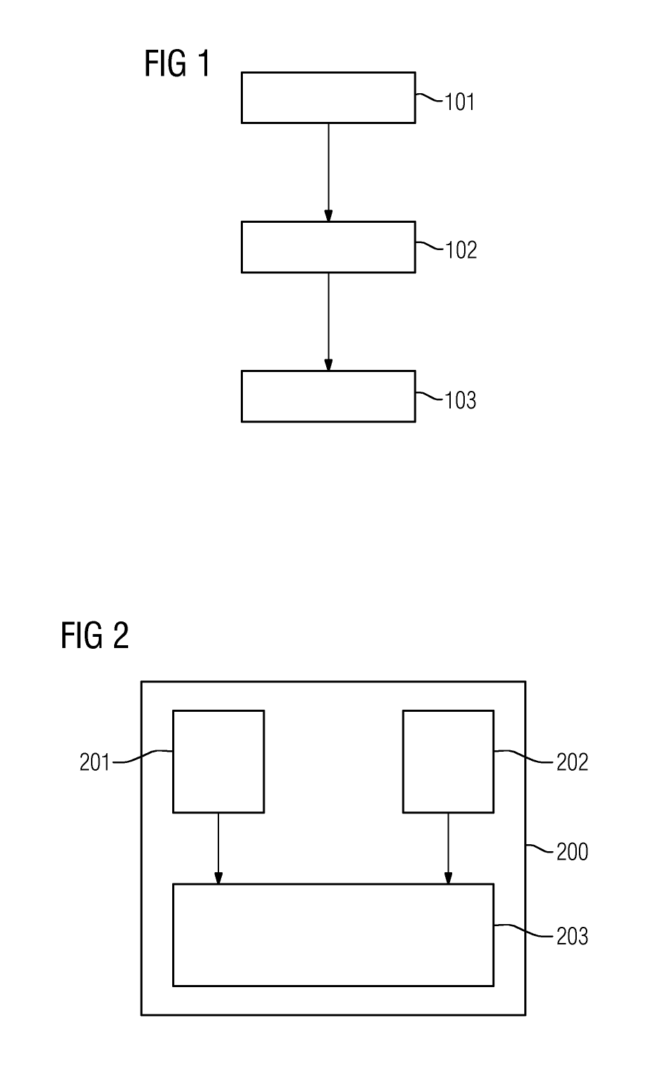

FIG. 1 shows a flowchart of an exemplary embodiment of a method for securing a block cipher F, encrypted with a working key K₀, against template attacks.

A working permutation F(K₀) fixed by the block cipher F and the working key K₀ is provided in step 101. The working key K₀ is in particular permanently allocated to the block cipher F.

In step 102 a number N of dummy permutations G(K₁), . . . , G(Kₙ) is provided. The N dummy permutations G(K₁), . . . , G(Kₙ) are fixed by N dummy keys K₁, . . . , Kₙ and the block cipher F or the inverse F⁻¹ of the block cipher F.

In step 103 the working permutation F(K₀) and the N dummy permutations G(K₁), . . . , G(Kₙ) are chained to form a chain H in such a way that the chain H and the working permutation F(K₀) produce an identical image (H=F(K₀)).

The N dummy keys K₁, . . . , Kₙ may be permutated or re-formed before each application of steps 101 to 103.

Steps 101 to 103 are implemented by a computer program product by way of example, which causes steps 101 to 103 to be carried out on a program-controlled device, by way of example on a processor.

FIG. 2 shows a block diagram of an exemplary embodiment of a device 200 for securing a block cipher F, encrypted with a working key K₀, against template attacks.

The device 200 has a first means 201, a second means 202 and a third means 203. The first means 201 is set up to provide a working permutation F(K₀) fixed by the block cipher F and the working key K₀. The second means 202 is set up to provide a number N of dummy permutations G(K₁), . . . , G(Kₙ). The N dummy permutations G(K₁), . . . , G(Kₙ) are fixed by N dummy keys K₁, . . . , Kₙ and the block cipher F or the inverse F⁻¹ of the block cipher F. The third means 203 is set up to chain the working permutation F(K₀) and the N dummy permutations G(K₁), . . . , G(Kₙ) to form a chain H in such a way that the chain H and the working permutation F(K₀) produce an identical image (H=F(K₀)).

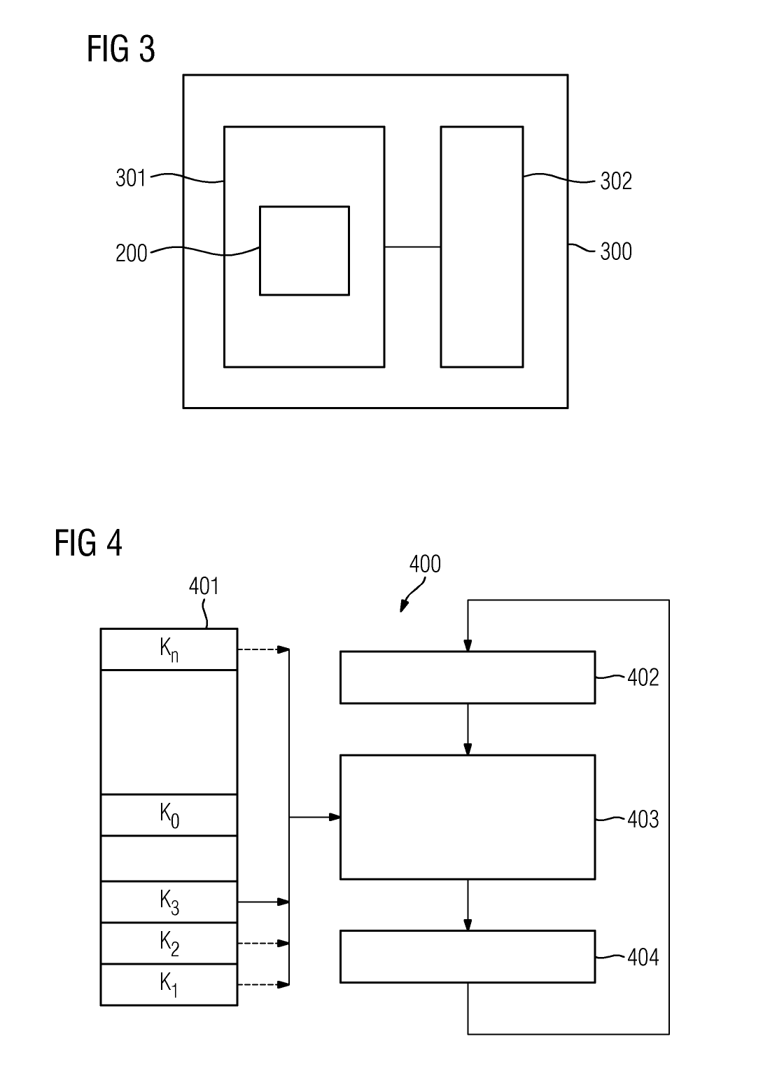

FIG. 3 shows a block diagram of an exemplary embodiment of a processor 300 having a device 200 according to FIG. 2. The device 200 is implemented by way of example as part of the CPU 301 of the processor 300, which is coupled to a memory 302. The working key K₀ and the dummy keys K₁, . . . , Kₙ in particular can be stored in the memory 302.

FIG. 4 shows a block diagram of a further exemplary embodiment of a device 400 for securing a block cipher against template attacks.

The device 400 in FIG. 4 has a key store 401 for storing the keys K1, . . . , Kₙ, an input 402 for an application means 403, the application means 403 and an output 404 of the application means 403. The output 404 is fed back to the input 402.

The application means 403 integrates the functions of the first means 201, the second means 202 and the third means 203 in FIG. 2 in particular.

The key store 401 provides the keys K1, . . . , Kₙ in the desired sequence. Encryption begins in that the input 402 provides the application means 403 with the plaintext m and the application means 403 executes the algorithm G with the first key K1. The plaintext m is encrypted to give G(K₁) (m). This first cipher text G(K₁) (m) is fed back from the output 404 into the input 402 and therewith into the application means 403. Encryption is then performed with the key K₂ to give G(K₂) (G) (K₁) (m). Encryption is carried out accordingly until the last key Kₙ has been used.

Although the invention has been illustrated and described in more detail by exemplary embodiments, it is not limited by the disclosed examples and other variations can be derived here-from by the person skilled in the art without departing from the scope of the invention.

What is claimed is:

1. A method for securing a block cipher (F), encrypted with a working key (K₀), against template attacks, the method comprising:
a) providing a working permutation (F(K₀)) fixed by the block cipher (F) and the working key (K₀),
b) providing a number N of dummy permutations (G(K₁), . . . , (G(Kₙ)) that are fixed by N dummy keys (K₁, . . . , Kₙ) and the block cipher (F) or an inverse (F⁻¹) of the block cipher (F), and
c) chaining the working permutation (F(K₀)) and the dummy permutations (G(K₁), . . . , (G(Kₙ)) to form a chain such that the chain and the working permutation (F(K₀)) produce an identical image.

2. The method of claim 1, wherein the number N of dummy permutations (G(K₁), . . . , (G(Kₙ)) is provided such that each chain of N dummy permutations (G(K₁), . . . , G(Kₙ)) produces a pre-image set of the block cipher (F).

3. The method of claim 2, wherein the chain of N dummy permutations is achieved by a first model having (g₁ o g₁⁻¹) o (g₂ o g₂⁻¹) o . . . o (gₙ o gₙ⁻¹), where gᵢ=G(Kᵢ), wherein G designates the block cipher (F) or the inverse (F⁻¹) of the block cipher, and wherein Kᵢ, where iε[1, . . . , n], designates the N dummy keys (K₁, . . . , Kₙ).

4. The method of claim 2, wherein the chain of N dummy permutations is achieved by a second model having (g₁ o g₂ o . . . o gₙ) o (gₙ⁻¹ o . . . o g₂⁻¹ o g₁⁻¹), where gᵢ=G(Kᵢ), wherein G designates the block cipher (F) or the inverse (F⁻¹) of the block cipher, and wherein Kᵢ, where iε[1, . . . , n], designates the N dummy keys (K₁, . . . , Kₙ).

5. The method of claim 2, wherein the chain of N dummy permutations is achieved by a third model having (g₁ o g₂ o g₃⁻¹) o (g₃ o g₂⁻¹ o g₁⁻) o (g₄ o g₅ o g₆⁻¹) o (g₆ o g₅⁻¹ o g₄⁻¹) o . . . , where gᵢ=G(Kᵢ), wherein G designates the block cipher (F) or the inverse (F⁻¹) of the block cipher, and wherein Kᵢ, where i ε[1, . . . , n], designates the N dummy keys (K₁, . . . , Kₙ).

6. The method of claim 5, wherein an implementation of a triple DES encryption is secured using the third model.

7. The method of claim 1, wherein the N dummy keys (K₁, . . . , Kₙ) are permutated before each application of steps a) to c).

8. The method of claim 1, wherein the N dummy keys (K₁, . . . , Kₙ) are re-formed before each application of steps a) to c).

9. The method of claim 1, wherein the working key (K₀) is permanently allocated to the block cipher (F).

10. A computer program product for securing a block cipher (F), encrypted with a working key (K₀), against template attacks, the computer program product being embodied in non-transitory computer readable media and executable by a processor to: provide a working permutation (F(K₀)) fixed by the block cipher (F) and the working key (Kd₀),
provide a number N of dummy permutations (G(K₁), . . . , (G(Kₙ)) that are fixed by N dummy keys (K₁, . . . , Kₙ) and the block cipher (F) or an inverse (F⁻¹) of the block cipher (F), and
chain the working permutation (F(K₀)) and the dummy permutations (G(K₁), . . . , (G(Kₙ)) to form a chain such that the chain and the working permutation (F(K₀)) produce an identical image.

11. The computer program product of claim 10, wherein the number N of dummy permutations (G(K₁), . . . , (G (Kₙ)) is provided such that each chain of N dummy permutations (G(K₁), . . . , G(Kₙ)) produces a pre-image set of the block cipher (F).

12. The computer program product of claim 11, wherein the chain of N dummy permutations is achieved by a first model having (g₁ o g₁⁻¹) o (g₂ o g₂⁻¹) o . . . o (gₙ o gₙ⁻¹), where gᵢ=G(Kᵢ), wherein G designates the block cipher (F) or the inverse (F⁻¹) of the block cipher, and wherein Kᵢ, where iε[1, . . . , n], designates the N dummy keys (K₁, . . . , Kₙ).

13. The computer program product of claim 11, wherein the chain of N dummy permutations is achieved by a second model having (g₁ o g₂ o . . . o gₙ) o (gₙ⁻¹ o . . . o g₂⁻¹ o g₁⁻¹), where gᵢ=G(Kᵢ), wherein G designates the block cipher (F) or the inverse (F⁻¹) of the block cipher, and wherein Kᵢ, where iε[1, . . . , n], designates the N dummy keys (K₁, . . . , Kₙ).

14. The computer program product of claim 11, wherein the chain of N dummy permutations is achieved by a third model having (g₂ o g₂ o g₃⁻¹) o (g₃ o g₂⁻¹ o g₁⁻¹) o (g₄ o g₅ o g₆⁻¹) o (g₆ o g₅⁻¹ o g₄⁻¹) o . . . , where gᵢ=G(Kᵢ), wherein G designates the block cipher (F) or the inverse (F⁻¹) of the block cipher, and wherein Kᵢ, where iε[1, n], designates the N dummy keys (K₁, . . . , Kₙ).

15. The computer program product of claim 14, wherein an implementation of a triple DES encryption is secured using the third model.

16. The computer program product of claim 10, wherein the N dummy keys (K₁, . . . , Kₙ) are permutated before each application of steps a) to c).

17. The computer program product of claim 10, wherein the N dummy keys (K₁, . . . , Kₙ) are re-formed before each application of steps a) to c).

18. The computer program product of claim 10, wherein the working key (K₀) is permanently allocated to the block cipher (F).
